(19) United States
(12) Patent Application Publication
(10) Pub. No.: US 2011/0017244 A1
(43) Pub. Date: Jan. 27, 2011

(54) DRY CLEANING AND SURFACE TREATMENT EQUIPMENT USED FOR BIOCHIP OR MEDICAL APPARATUS

(76) Inventors: Chi-Sang LAU, Taipei (TW); Yih Ming Jerng, Taipei (TW)

Correspondence Address: HDLS Patent & Trademark Services, P.O. BOX 220746, CHANTILLY, VA, 20153-0746, US

(21) Appl. No.: 12/509,786

(22) Filed: Jul. 27, 2009

(51) Int. Cl. B08B 3/00

(52) U.S. Cl. 134/105

(57) ABSTRACT

A dry cleaning and surface treatment equipment used for a biochip or a medical tools includes a sealable chamber provided for putting a biochip, an ozone generator for supplying ozone to the sealable chamber, and a fluid transmission device filled with a chemical reactant. The sealable chamber includes a heater, a gas outlet, and a gas inlet interconnected with the ozone generator. The fluid transmission device is disposed outside the sealable chamber and includes a trace transmission pipe extended to the fluid transmission device. The sealable chamber further includes an evaporation container, and the trace transmission pipe of the fluid transmission device is extended to a corresponding position of the evaporation container for injecting the chemical reactant into the evaporation container.

### BACKGROUND OF THE INVENTION

1. Field of the Invention

The present invention relates to a biological or medical apparatus, and more particularly to a dry cleaning and surface treatment equipment used for a biochip or medical tools.

2. Description of Prior Art

Pre-rinsing and surface treatment of chips has been a long existing problem for biological scientists to use biochips to conduct experiments, since the chips gone through a surface treatment are often deteriorated and cannot be kept even for a short time. Furthermore, the life expectancy of these biochips is very short, and these biochips are usually deteriorated or contaminated easily during their transportation from factories to end-users. Of course, the quality can be controlled if the biochips are fabricated directly in laboratories, but the equipment cost will be very high, and the production time will be very long. That is the reason why biochips produced directly in laboratories cannot be used extensively.

At present, contaminants on the surface of a biochip are generally cleaned by either a wet cleaning method or a dry cleaning method. In the wet cleaning method, chemicals are used for dipping and washing the chip, and most people adopt this method. The wet cleaning method requires lots of liquid chemicals including organic solvents and inorganic solvents or even strong acidic or alkaline solutions, and thus the wet cleaning method may create a secondary pollution easily or cause a poison leak during the cleaning process. Furthermore, there are issues of recycling chemical wastes and requiring a very clean place for rinsing the biochips. The wet cleaning method is unable to achieve such high standard and causes tremendous inconvenience to users, and thus the dry cleaning method is introduced. There are two common dry cleaning methods, respectively: plasma treatment and UV cleaning, and both are usually used in a semiconductor manufacturing process or for cleaning TFT glass substrates with an excellent effect. However, both methods have existing drawbacks such as the high-priced equipments and instruments, complicated equipments, and difficult operations. For instance, a small plasma treatment machine incurs a very high production cost and a price over US$30,000, and requires vacuum equipments as backup, and thus the plasma treatment machines cannot become low-priced equipments used extensively in laboratories, testing centers or hospitals. Most importantly, these two cleaning methods have a serious issue of cleaning dead spots. Since the rinsing used in a semiconductor manufacturing process or the cleaning of a TFT glass substrate is simply relates to planar cleaning, but a medical tools such as a surgery knife is an object that requires cleaning on many different sides, and both plasma cleaner and UV cleaning machine have difficulties to overcome this issue. Furthermore, UV lamps used in the UV cleaning method are operated in the high-temperature chamber, which gives rise to a short life expectancy of the UV lamps and a high risk of accidents. Both of the aforementioned two methods have drawbacks on their difficult operation and maintenance, and thus users must have to be well trained. In addition, these methods and operations incur a high cost and wastes much time.

The description shown above is cleaning. Following is a surface treatment adopting a chemical evaporation for cleaning the surface of an object used by the prior art. With reference to FIG. 1 for the method of operating aforementioned device, chemical reacting gases are inputted from the outside into a sealed chamber 1a, and then an object to be processed (such as a biochip) 2a and the chemical reacting gases are heated to a high temperature to produce a chemical vapor deposition (CVD) effect for processing the gases and the object to be processed 2a in the sealed chamber 1a. Chemical reactants (such as silane and water) are put into the heating flask 3a, and a small heater 30a is installed at the bottom of a flask 3a. After the chemical reactants are heated, vapors are produced and then introduced into the sealed chamber 1a through a duct 31a for the reaction, such that the object to be processed 2a can be activated.

However, liquid chemical compounds are heated and converted into a gaseous state before they are injected into the sealed chamber 1a, and this method is adopted by present existing CVD and MO. C.V.D processes. Since many chemical reactants are in a liquid state at room temperature, therefore it is necessary to heat the chemical reactants into a vapor state, and there is a drawback of this method that the gases will be cooled and liquefied in the duct 31a to block the duct 31a. This is a big issue to the semiconductor manufacturing industry. In one of the present solutions, a heating plate (not shown in the figure) is wrapped around the duct 31a, such that the chemical reactants can be maintained at a gaseous state, but this solution also incurs a higher manufacturing cost and causes a more difficult maintenance.

In view of the foregoing shortcomings of the prior art, the inventor of the present invention based on years of experience in the related industry to conduct extensive researches and experiments, and finally developed a reasonable design and provided a feasible solution to overcome the shortcomings of the prior art effectively.

### SUMMARY OF THE INVENTION

It is a primary objective of the present invention to overcome the shortcomings of the prior art by providing a dry cleaning and surface treatment equipment used for a biochip or a medical apparatus, so that the duct will not be blocked by the liquid chemical reactants after the gaseous chemical reactants are cooled and condensed into a liquid state, without increasing the equipment and manufacturing costs or causing a difficult maintenance.

To achieve the foregoing objective, the present invention provides a dry cleaning and surface treatment equipment used for a biochip or a medical tools, comprising a sealable chamber, an ozone generator, and a fluid transmission device; wherein the sealable chamber is provided for placing an object to be processed such as a biochip or a medical tools, and includes a heater for changing the internal temperature of the sealable chamber, and the sealable chamber includes a gas outlet and a gas inlet interconnected to the ozone generator for supplying ozone to the sealable chamber, and the fluid transmission device used for filling chemical reactants is disposed outside the sealable chamber and extended to a trace transmission pipe in the sealable chamber. The sealable chamber further includes an evaporation container, and the trace transmission pipe of the fluid transmission device is extended to a corresponding position of the evaporation container for injecting chemical reactants into the evaporation container.

After the fluid transmission device injects the chemical reactants into the sealable chamber in accordance with the present invention, the chemical reactants are contained in the evaporation container, and heated in the sealable chamber to form vapors, and thus there is no issue of condensing the chemical reactants from a gaseous state into a liquid state during the input process, or blocking the transmission pipeline by the chemical reactants in the liquid state. In other words, it is not necessary to install the heating plate to maintain the chemical reactants at the gaseous form during the input process, so as to overcome the aforementioned shortcomings of the prior art including the increase of manufacturing and equipment costs and difficulty of the maintenance.

### BRIEF DESCRIPTION OF DRAWINGS

FIG. 1 is a schematic view of a structure of a conventional equipment used for surface treatment of an object by a chemical vapor reaction; and

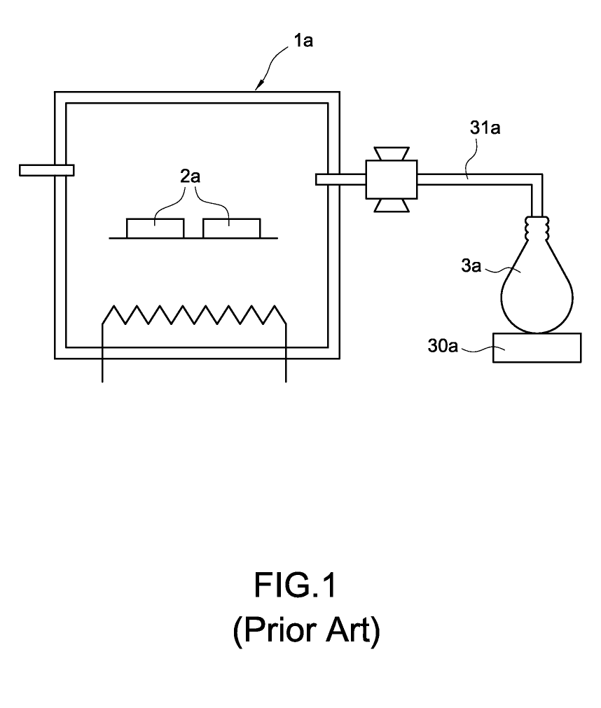

FIG. 2 is a schematic view of a structure of the present invention.

### DETAILED DESCRIPTION OF THE INVENTION

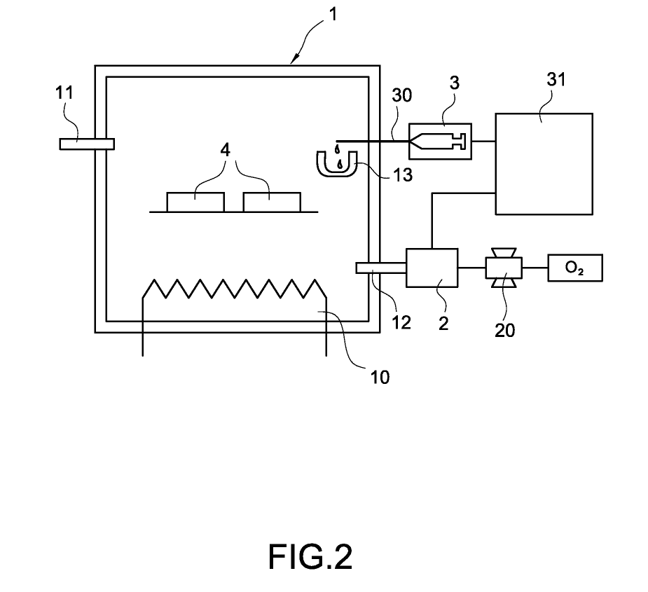

The technical characteristics, features and advantages of the present invention will become apparent in the following detailed description of preferred embodiments with reference to the accompanying drawings, and the preferred embodiments are used for illustrating the present invention only, but not intended to limit the scope of the invention. With reference to FIG. 2 for a schematic view of a structure of the present invention, the present invention provides a dry cleaning and surface treatment equipment used for a biochip or a medical tools, comprising a sealable chamber 1 for placing an object to be processed 4 (such as a biochip or a medical tools), an ozone generator 2, and a fluid transmission device 3.

The sealable chamber 1 is provided for placing the object to be processed 4, and includes a gas outlet 11 and a gas inlet 12, wherein the gas inlet 12 is interconnected with the ozone generator 2 to facilitate ozone (O₃) to be entered from the gas inlet 12 and discharged from the gas outlet 11, and the ozone generator 2 is connected to an oxygen valve 20 for providing an input of oxygen (O₂) and controlling the inputted quantity of oxygen. If the oxygen entering into the oxygen valve 20 is activated to form ozone, the ozone will be introduced into the sealable chamber 1. To heat the ozone, a heater 10 is installed in the sealable chamber 1 for changing the temperature inside the sealable chamber 1 to heat up the ozone and the supplied high-temperature ozone to the object to be processed 4.

The main purpose of the present invention is to provide an equipment having a fluid transmission device 3 with a trace transmission pipe 30 installed outside the sealable chamber 1 for filling the required chemical reactant, and an evaporation container 13 disposed inside the sealable chamber 1, such that the trace transmission pipe 30 of the fluid transmission device 3 can be extended into the sealable chamber 1, and extended to a corresponding position (such as the top) of the evaporation container 13 for injecting the chemical reactant directly from the trace transmission pipe 30 into the evaporation container 13 of the sealable chamber 1. Meanwhile, the heater 10 also provides the required temperature for the reaction, such that the chemical reactant in the evaporation container 13 of the sealable chamber 1 is heated to produce a vapor source, and the chemical reactant is heated to form gases, which is an organic or inorganic gas. If several chemical reactants are involved, then more fluid transmission devices 3 can be installed according to the actual requirement.

In a preferred embodiment of the present invention, the fluid transmission device 3 is an injector, and the trace transmission pipe 30 is a needle head of the injector. The fluid transmission device 3 is a pump (not shown in the figure) for controlling the trace fluid transmission. In addition, the fluid transmission device 3 includes a computer controller 31 for controlling the injected dosage of the chemical reactants. If it is necessary to conduct a CVD chemical reaction process at low pressure, then the sealable chamber 1 must be sealed and vacuumed, and a vacuum pump may be installed if necessary.

With the aforementioned components, the dry cleaning and surface treatment equipment used for a biochip or a medical tools in accordance with the present invention is achieved.

During the operation of the equipment, the biochip (which is the object to be processed 4) is cleaned in advanced, and then put into the sealable chamber 1. Now, the working temperature of the heater 10 can be set, and the ozone generator 2 is turned on and the external oxygen is added, so that the ozone entered into the sealable chamber 1 will oxidize organic pollutants on a surface of the high-temperature biochip. The supply of ozone entering into sealable chamber 1 is stopped if the set time is reached, and then the working temperature of the heater 10 is changed to the reaction temperature of the chemical reactant. The computer controller 31 is provided for adjusting the required dosage of chemical reactant to be filled into the fluid transmission device 3 and injected into the sealable chamber 1, so that the reaction temperature set for the heater 10 in the sealable chamber 1 is increased for heating the chemical reactant into vapor. Now, the surface of the biochip is activated by the conditions such as the specific chemical gas composition and temperature, or the conditions can be changed according to actual requirements. After the set time is reached, users can turn off the cleaning equipment, and remove the biochip when cooled.

In the dry cleaning and surface treatment equipment used for a biochip or a medical tools in accordance with the present invention, the chemical reactants are injected into the sealable chamber 1 by the fluid transmission device 3, and contained in the evaporation container 13, so that the chemical reactants can be heated into vapors in the sealable chamber 1, and the chemical reactants in a gaseous state will not be converted back to a liquid state, or block the transmission pipeline by the chemical reactants in the liquid state. In addition, there is no need of installing a heating plate to maintain the gaseous state of the chemical reactants in the input process, and thus there will be no issue of increasing the manufacturing cost or the level of difficulty for the maintenance.

In summation of the description above, the invention can achieve the expected objectives and overcome the shortcomings of the prior art. The invention complies with the requirements of patent application and is thus duly filed for patent application. While the invention has been described by means of specific embodiments, numerous modifications and variations could be made thereto by those skilled in the art without departing from the scope and spirit of the invention set forth in the claims.

What is claimed is:

1. A dry cleaning and surface treatment equipment used for a biochip or a medical tools, comprising:
a sealable chamber, for placing an object to be processed, and having a gas outlet and a gas inlet disposed thereon, and a heater capable of changing an internal temperature of the heater;
an ozone generator, interconnected with the gas inlet of the sealable chamber, for supplying ozone to the sealable chamber; and
a fluid transmission device, for filling a chemical reactant, and having a trace transmission pipe disposed outside the sealable chamber and extended into the sealable chamber;
wherein the sealable chamber further comprises an evaporation container, and the trace transmission pipe of the fluid transmission device is extended to a corresponding position of the evaporation container for injecting the chemical reactant into the evaporation container.

2. The dry cleaning and surface treatment equipment used for a biochip or a medical tools, as recited in claim 1, wherein the sealable chamber further includes a vacuum pump.

3. The dry cleaning and surface treatment equipment used for biochip or medical tools, as recited in claim 1, wherein the ozone generator further includes an oxygen valve for providing an oxygen input.

4. The dry cleaning and surface treatment equipment used for a biochip or a medical tools, as recited in claim 1, wherein the fluid transmission device is an injector, and the trace transmission pipe is a needle head of the injector.

5. The dry cleaning and surface treatment equipment used for a biochip or a medical tools, as recited in claim 1, wherein the fluid transmission device is a pump capable of controlling a trace fluid transmission.

6. The dry cleaning and surface treatment equipment used for a biochip or a medical tools, as recited in claim 1, wherein the fluid transmission device comes with a plural quantity.

7. The dry cleaning and surface treatment equipment used for a biochip or a medical tools, as recited in claim 1, wherein the fluid transmission device supplies a required dosage of the injected chemical reactant through a computer controller.

8. The dry cleaning and surface treatment equipment used for a biochip or a medical tools, as recited in claim 1, wherein the trace transmission pipe of the fluid transmission device extended to a corresponding position of the evaporation container refers to the top of the evaporation container.
